(19) United States
(12) Patent Application Publication
(10) Pub. No.: US 2003/0187825 A1
(43) Pub. Date: Oct. 2, 2003

(54) Method of controlling storage system, storage unit, management unit, and program therefor

(75) Inventor: Kenzo Tabata, Odawara (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/274,468

(22) Filed: Oct. 17, 2002

(30) Foreign Application Priority Data
Mar. 27, 2002 (JP) P2002-089261

(51) Int. Cl. G06F 7/00

(52) U.S. Cl. 707/1

(57) ABSTRACT

A storage system includes a first storage unit, user units connected to the first storage unit and exchanging data to the storage region offered by the first storage unit, an auxiliary storage unit connected to the first storage unit to offer a storage region for expanding the storage region offered by said first storage unit; and a management unit connected to the first storage unit and to the user units and that assigns the storage region to the user units. In the method the first storage unit sends, to the management unit, a capacity calculated from the capacity of the storage region which can be offered by the first storage unit itself and from the capacity of the storage region offered by the auxiliary storage unit; and the management unit receives the calculated capacity and recognizes it as an upper-limit capacity that can be assigned to the user units from the first storage unit or from the auxiliary storage unit.

### BACKGROUND OF THE INVENTION

1. Field of the Invention

This invention relates to a method of controlling a storage system, and to a storage unit, a management unit and a program therefor.

2. Description of the Related Art

FIG. 7 is a diagram illustrating a general form of storage system used in a modem data center and the like. Host computers 10 for operating a web server and a database, and a storage 11 are connected through a storage area network (SAN) 12. The storage 11 is, for example, a disk array unit. The storage regions of storage 11 fed by a disk drive are assigned to host computers 10 by a method such as zoning or LU masking.

The capacity of the storage region that storage 11 can offer to host computers 10 is determined by the capacity and number of the disk drives loaded in storage 11. Therefore, when the remaining capacity of the storage region in the storage 11 is not sufficient, it is necessary to call for a service technician from a storage vendor to install an additional disk drive or to otherwise provide additional storage.

The above operational method, however, may not be capable of coping with an increase in the disk drives and may cause trouble in the operation of the system when use of the storage expands unexpectedly, such as when the number accesses of a web page rapidly increases. If it is attempted to quickly cope with the problem by detecting the lack of residual capacity in advance, it becomes necessary to monitor the residual capacity in real time, increasing the burden on the operation.

### BRIEF SUMMARY OF THE INVENTION

This invention helps solve the problem discussed above, and provides a method of controlling a storage system which is capable of offering a storage region of a required capacity at all times, and a storage system itself. This invention is principally concerned with a method of controlling a storage system which includes a first storage unit; user units connected to the storage unit maintaining communication therewith, and exchanging data to the storage region offered by the first storage unit; an auxiliary storage unit connected to the storage unit and maintaining communication therewith to offer a storage region for expanding the storage region offered by the first storage unit; and a management unit connected to the first storage unit and to the user units maintaining communication therewith, and assigning a storage region to the user units. Preferably, the first storage unit sends to the management unit a capacity calculated from the capacity of the first storage region, which can be offered by the first storage unit itself and from the capacity of the storage region offered by the auxiliary storage unit. The management unit receiving the calculated capacity and recognizes it as an upper-limit capacity that can be assigned to the user units from the first storage unit or from the auxiliary storage unit.

In this control method, the calculation includes such operations as addition and subtraction. The method of calculation may use all or part of the capacity of the storage region that can be offered by the first storage unit, or may use all or part of the capacity of the storage region offered by the auxiliary storage unit. The user unit is, for example, a host computer, and the first storage unit is, for example, a local storage unit connected to the host computer through the SAN. The auxiliary storage unit is a remote storage unit or the like connected to the local storage unit through a dedicated circuit.

According to this method, the local storage unit sends to the management unit a capacity calculated from the capacity of the storage region that can be offered by the local storage unit itself and from the capacity of the storage region offered by the remote storage unit, and the management unit receives the calculated capacity and recognizes it as an upper-limit capacity that can be assigned to the host computers. Here, the recognition consists of, for example, storing the calculated capacity and using the stored value as an upper-limit capacity at the time of assigning it to the storage regions of the host computers.

That is, the host computer can be assigned the storage capacity obtained by adding the storage capacity offered by the remote storage unit to the storage capacity offered by the local storage unit. For example, on securing a sufficiently large storage capacity on the remote storage side, operation of the system is not hindered even if storage region consumption expands unexpectedly. Further, there is no need to monitor the remaining capacity in real time. This makes it possible to fully cope with the demand for securing the storage region conservation margin.

Another aspect of this invention is concerned with a method of controlling a storage system which includes a first storage unit; user units connected to the first storage unit maintaining communication therewith, and the exchange of data to and from the storage region offered by the storage unit; and an auxiliary storage unit connected to the first storage unit maintaining communication therewith to offer a storage region for expanding the storage region offered by the first storage unit. Preferably, the first storage unit sends to the user units, a capacity, calculated from the capacity of the first storage region, which can be offered by the storage unit itself and from the capacity of the storage region offered by the auxiliary storage unit; and the user units recognize the calculated capacity as an upper-limit capacity that can be assigned to the user units in assigning the storage region offered by the storage unit or by the auxiliary storage unit.

In this control method the user units execute the function of the management unit. This eliminates the need of providing the management unit, and makes it possible to eliminate the burden of operating the management unit and to eliminate the cost for operation thereof. The storage unit may offer the user units the storage region in a unit of a logic volume which is logically compiled on a physical storage region offered by the first storage unit or by the auxiliary storage unit. In this case, the storage unit transmits the calculated capacity set for each of the logic volumes to the management unit or to the user units.

In addition, the storage unit may transmit the capacity set for each of a plurality of logic volumes to the management unit or to the user unit. The first storage unit may further set the calculated capacity for the first logic volume compiled by using the auxiliary storage unit based on the capacity set for the auxiliary logic volume. Specifically, the calculated capacity of the logic volume compiled by using the auxiliary storage unit is set to be larger than the capacity set for the auxiliary logic volume. This makes it possible to increase variations of the logic volume assigned to the host computers.

The user units or the management unit is equipped with a user interface for specifying the storage capacity assigned to the user units themselves with the above upper-limit capacity as a limit. The auxiliary storage unit is installed at a place remote from the first storage unit.

The function for receiving the calculated capacity sent from the storage unit and the function for recognizing the calculated capacity as an upper-limit capacity that can be assigned to the user units, are carried out by the first storage unit, by the user units or by a predetermined program operated by the management unit.

The invention is further concerned with storage units in a storage system in which a plurality of the storage units are connected through a fiber channel to write and read data based on a request from a data processing unit. The storage system includes a management unit for assigning the plurality of storage units connected to the fiber channel to data processing units. In this implementation, the storage units are connected through a dedicated circuit to other storage units that write or read data in response to requests from the various storage units, and possess data for managing the state of use of the other storage units. The storage units refer to the data for managing the state of use, add up or subtract the storage capacity that can be offered from the storage units to the data processing units, including the storage capacity in the other storage units, and send the management unit the capacity that can be assigned to the data processing units.

Here, the data processing units are, for example, host computers that will be described later, and the principal storage units and other storage units are, for example, local storage units and remote storage units that will be described later. Further, the data for managing the state of use of other storage units are those data included, for example, in configuration data that will be described later. Thus, a benefit of this invention is that it offers a storage region of a required capacity at all times.

### BRIEF DESCRIPTION OF THE DRAWINGS

FIG. 1 is a schematic diagram of the configuration of a storage system according to an embodiment of this invention;

FIG. 2 is a diagram illustrating configuration data according to the embodiment of this invention;

FIG. 3 is a diagram illustrating a set screen displayed on a management terminal in assigning the logic volume according to an embodiment of this invention;

FIG. 4 is a flow chart of a process for writing into the logic volume according to an embodiment of this invention;

FIG. 5 is a flowchart of a processing for writing into the logic volume according to an embodiment of this invention;

FIG. 6 is a flowchart of a process for reading from the logic volume according to an embodiment of this invention; and

FIG. 7 is a diagram illustrating the configuration of a conventional storage system.

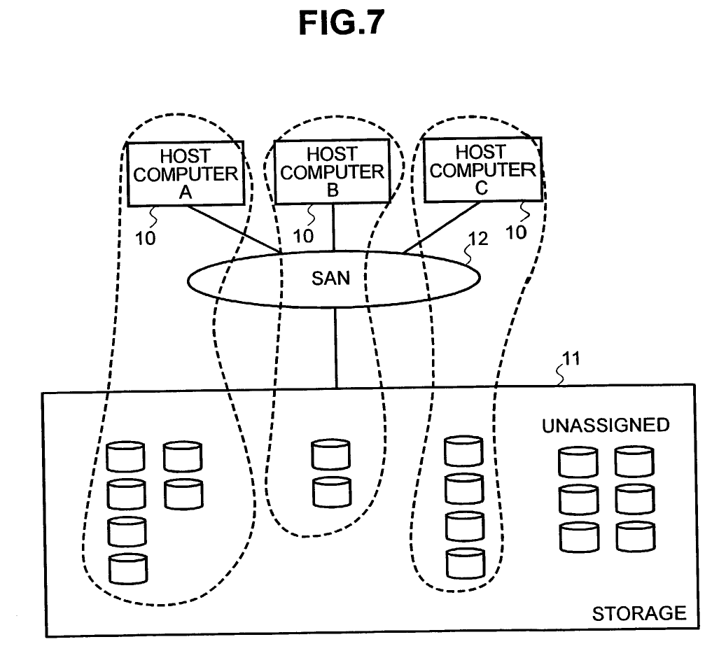

### DETAILED DESCRIPTION OF THE INVENTION

System Configuration.

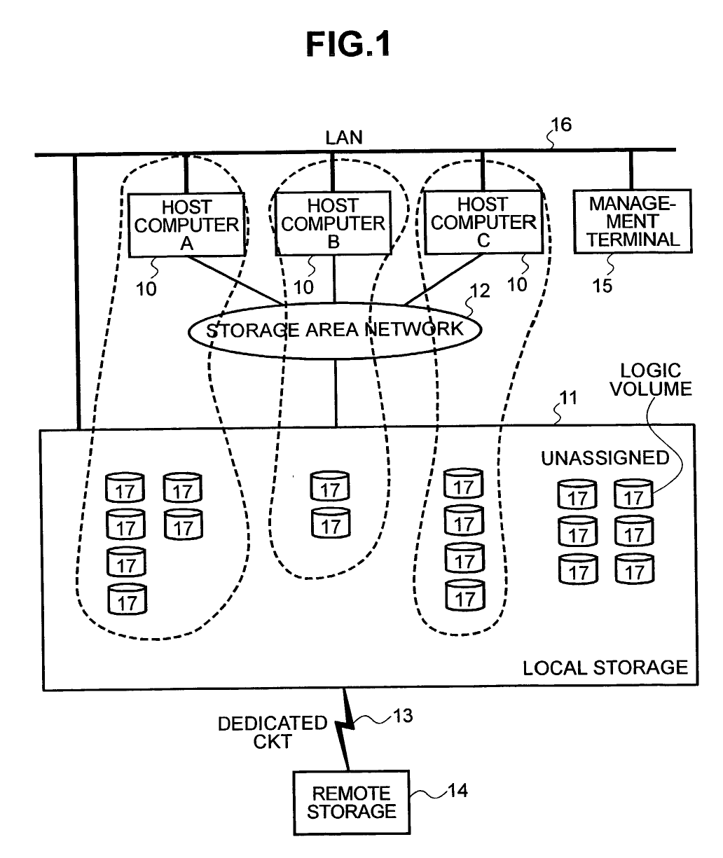

FIG. 1 illustrates the configuration of a storage system according to an embodiment of the invention. The storage system includes host computers 10 which are general-purpose open computers or personal computers, a local storage 11 which is a disk array unit f or providing host computers 10 with storage regions, a SAN 12 for connecting them, and a remote storage 14 connected to the local storage 11 through a communication means 13 such as a dedicated circuit.

Local storage 11 provides host computers 10 with storage regions through SAN 12. Local storage 11 includes a disk drive, a CPU, a control memory for storing various setting data and tables, a cache memory, a data controller for controlling the input/output of data to and from the disk drive, a fiber channel interface, and a communication interface for connection to remote storage 14.

A management terminal 15 is connected to host computers 10 and to local storage 11 via a LAN (local area network) 16. Management terminal 15 communicates with host computers 10 and local storage 11 relying on SNMP (simple network management protocol).

Remote storage 14 is installed at a place such as a service center operated by an enterprise contractor who runs the IDC or by a storage vender remotely located from local storage 11. Remote storage 14 provides host computers 10 with storage regions through local storage 11.

The storage region is assigned to host computer 10 in a unit of a logic volume 17, which is a logic storage region compiled on a physical volume offered by the disk drive of local storage 11. Logic volumes 17 are assigned to host computers 10 by setting the zoning or by setting the LU masking.

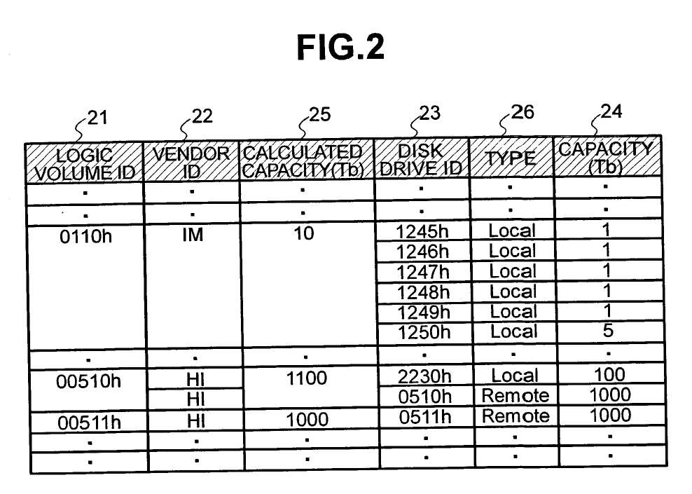

Assigning logic volumes 17 to host computers 10 is managed by the configuration data stored in local storage 11. FIG. 2 illustrates an example of configuration data. In column 21, “Logic Volume ID,” of FIG. 2, is listed an ID (identifier) which is uniquely assigned to compiled logic volume 17. In column 22, “Vender ID,” is listed an ID given to a storage vender for logic volume 17. In column 23, “Disk Drive ID,” is listed an ID that is given to the disk drive mounted on local storage 11 or on remote storage 14. In column 24, “Capacity,” is listed the storage capacity of each disk drive. In column 25, “Calculated Capacity,” is listed the total capacity of all disk drives corresponding to a logic volume ID.

In column 26, “Type,” the term “Local” is listed when the disk drives constituting logic volumes 17 are those of local storage 11, and “Remote” is listed when the disk drives are those of remote storage 14. When the logic volume ID is “00510 h” in FIG. 2, logic volume 17 is often compiled by both the disk drive of local storage 11 and the disk drive of remote storage 14.

Logic volumes 17 are assigned to host computers 10 as an operator operates management terminal 15. The assignment is effected when host computers 10 are newly introduced into the storage system or when the remaining capacities are getting small in the logic volumes assigned to host computers 10.

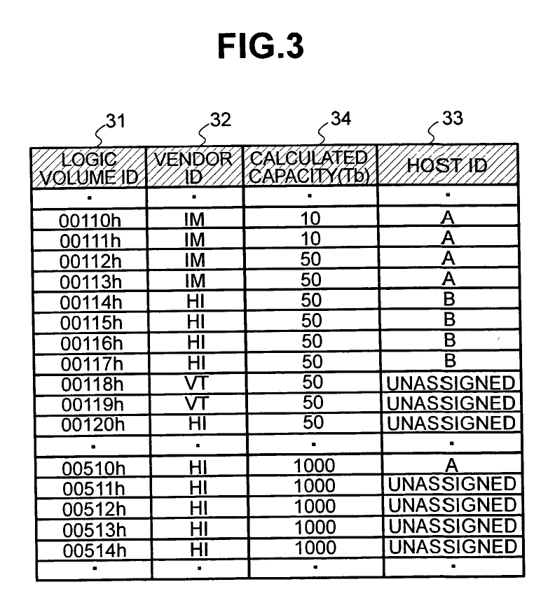

FIG. 3 shows a set screen displayed on management terminal 15 at the time of assignment. On the screen is listed the state of logic volumes 17. The logic volume ID mentioned above is listed in column 31, “Logic Volume ID” The ID of the storage vendor of corresponding logic volume 17 is listed in column 32, “Vendor ID.” Here, the content of column 32 is used as a reference for selecting logic volume 17 or as data for specifying where to call in case of trouble.

In column 33, “Host ID,” is displayed the ID of the host computer 10 to which the logic volume 17 is assigned. If “Unassigned” has been listed in column 33, “Host ID,” it means that the logic volume has been assigned to none of the host computers. When a logic volume is assigned to a host computers by the operator, or the like, as will be described later, then, the ID of the host computer to which the logic volume 17 is assigned is listed in column 33. Capacities (corresponds to column 25 of FIG. 2) of logic volumes 17 are listed in column 34, “Calculated Capacity.”

While looking at the set screen of FIG. 3, the operator operates management terminal 15 to assign logic volume 17 to host computer 10. For example, at a real operation site such as a data center, the operator of a host computer 10 selects logic volume 17 to be assigned to his own host computer relying upon such data as fees for using logic volume 17, quality of the guaranteed operation speed, additional value (e.g., security service, backup service, etc.) as well as data such as the policy for operating host computer 10. In assigning logic volume 17, as will be understood from the set screen of FIG. 3, the operator is unaware whether logic volumes 17 are using the disk drive of remote storage 14.

Upon using remote storage 14 as described above, a storage region of large capacity can be offered to host computer 10 without increasing the disk drive capacity in local storage 11. Upon setting up logic volume 17 by using the storage region of remote storage 14, it is possible to provide a logic volume 17 of a capacity that meets the need.

In recent years, an environment has been established for effecting high-speed communication among distant locations at decreased cost. Therefore, if remote storage 14 is installed at a place where the price of land is low, a logic volume 17 can be offered that may be used at a low unit price.

In the set screen of FIG. 2, moreover, a volume larger than the one set in column 25, “Calculated Capacity” of a second logic volume 17, may be set in the column 25, “Calculated Capacity” of logic volume 17 set up by using the storage region of remote storage 14.Thus, the choices of logic volumes 17 can be maintained to be not smaller than a constant number. Further, a maximum capacity that can be assigned to host computers 10 may be set in column 25, “Calculated Capacity,” or a maximum value that can be offered by remote storage 14 may be set therein.

Data Input/Output Processing.

Next, described below is the operation of the storage system when input or output of data is requested, through SAN 12, from a host computer 10 to the logic volume 17 assigned to that host computer.

First, the configurations of logic volumes 17 can be classified into <1> the one set up using disk drive of local storage 11 only, <2> the one set up by using both the disk drive of local storage 11 and the disk drive of remote storage 14, or <3> the one set up by using the disk drive of remote storage 14 only. Here, the type <1> is the same as that of the storage system of a conventional configuration using local storage 11 only, and is not described here. Described below are the cases where input/output of data is requested to or from logic volumes 17 of the types <2> and <3>.

In the following description, the local storage 11 and the remote storage 14 manage the storage region of logic volume 17 by using an address (hereinafter referred to as “local address”) assigned to the disk drive of local storage 11 and an address (hereinafter referred to as “remote address”) assigned to the disk drive of remote storage 14.

Further, local storage 11 and remote storage 14 store a “table for managing the state of use” of the storage regions each offers.

Write Processing

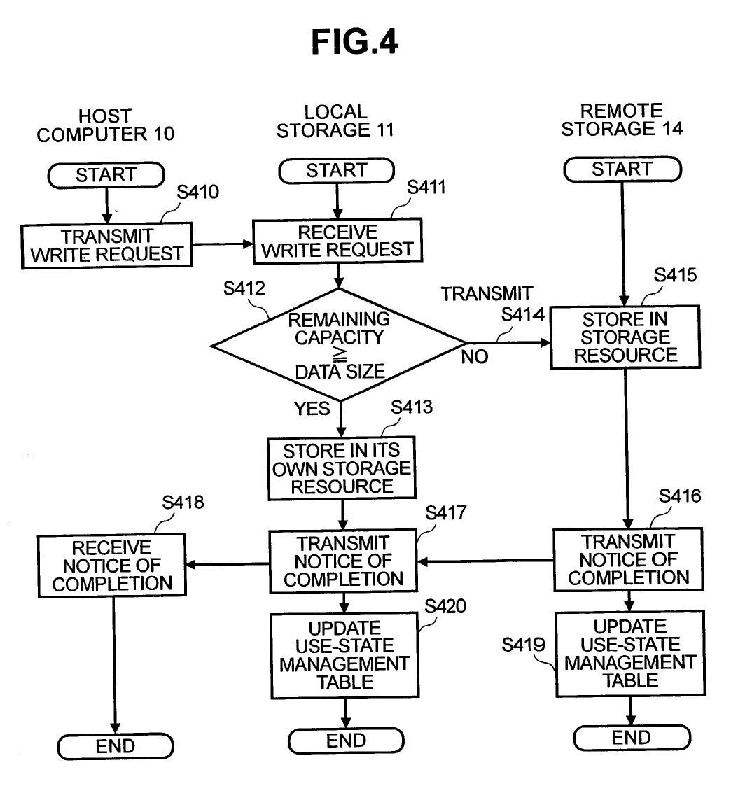

Processing when local storage 11 receives a request to write data onto logic volume 17 of type <2 > is now described with reference to the flowchart of FIG. 4. Upon receipt of a request for writing data onto logic volume 17 of type <2> from host computer 10 (S410 and S411), local storage 11 refers to the use-state management table and compares the remaining capacity of the disk drive in local storage 11, defined as constituent elements of logic volume 17 with the data size of the write request (S412).

When the remaining capacity is larger than the data size, local storage 11 stores the write data in the disk drive of local storage 11 containing logic volume 17 (S413). When the remaining capacity is smaller than the data size, on the other hand, local storage 11 transmits the data to remote storage 14 through the communication means (S414) Upon receipt of this data, remote storage 14 stores the data in its own disk drive. (S415).

Then, as required, a notice of completion is transmitted from remote storage 14 to local storage 11. Local storage 11 transmits to host computer 10 that sent the request for writing, a notice of completion of processing for the request (S416 to S418). During processing or at a suitable time after processing, local storage 11 and remote storage 14 update the contents of the use-state management tables stored therein (S419 and S420).

When the data size exceeds the remaining capacity of the disk drive in local storage 11 for the above processing, the write data are all transmitted to remote storage 14. It is, however, also allowable to divide the write data and store part of the data in local storage 11 and store the rest in remote storage 14. In this case, the data are managed for having data in local storage 11 that correspond to data in remote storage 14.

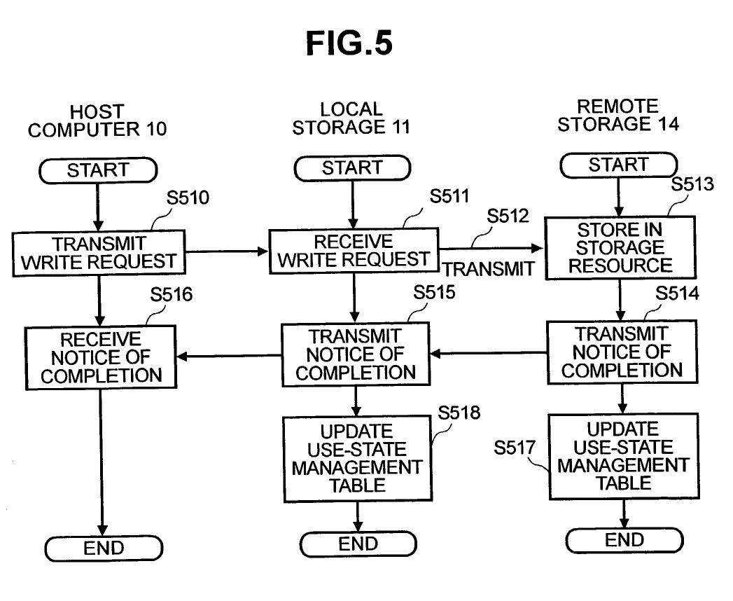

Next, described below with reference to the flowchart of FIG. 5 is a process used when local storage 11 receives a request to write data into logic volume 17 of type <3>. Upon receipt of a request from host computer 10 to write data into logic volume 17 of type <3> (S510 and S511), local storage 11 transmits the write data attached to the request to remote storage 14 (S512). Upon receipt of this data, remote storage 14 stores the data in its own disk drive. (S513).

Then, as required, remote storage 14 transmits a notice of completion to local storage 11. Local storage 11 transmits to host computer 10 that sent the write request, a notice of completion of processing for the request (S514 to S516). During processing or at a suitable time after processing, local storage 11 and remote storage 14 update the contents of the use-state management tables stored therein (S517 and S518).

Processing for Reading the Data.

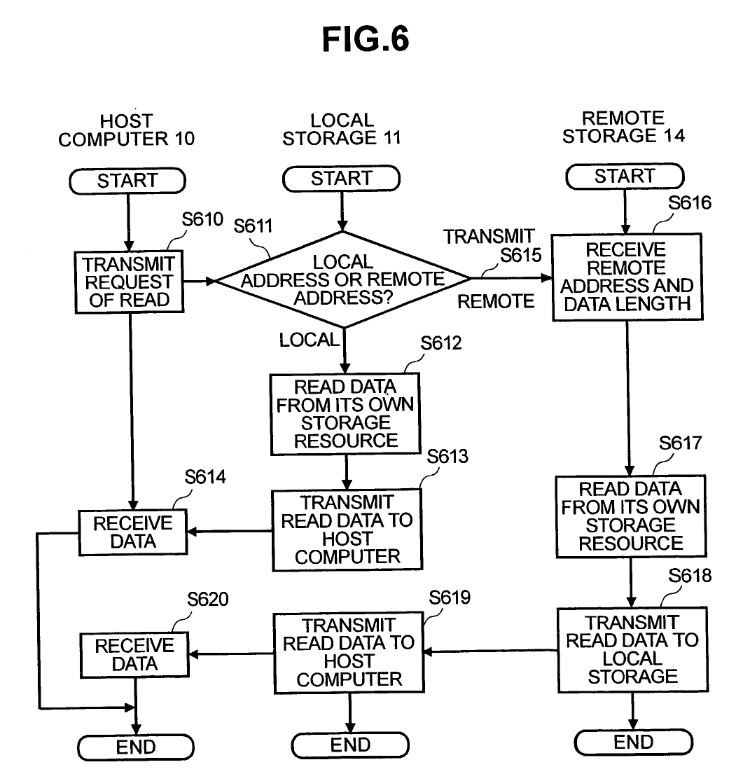

Next, processing for reading data from logic volume 17 is described with reference to the flowchart shown in FIG. 6. A request for reading, which local storage 11 receives from host computer 10, includes an address specifying the storage position of the data that are to be read and the data length.

Upon receipt of the request for reading (S610), local storage 111 checks whether the address attached thereto is a local address or a remote address (S611). When the address is local, local storage 11 reads the data of the specified length from the position specified by the address on its own disk drive (S612), and transmits the data to the host computers 10 (S613 and S614).

When the address is a remote address, on the other hand, local storage 11 transmits the address and the data length to remote storage 14 (S615). Remote storage 14, on receipt of the information, (S616) reads the data of the specified length from the position specified by the address on its own disk drive (S617), and transmits the data to local storage 11 (S618). Upon receipt of the data, local storage 11 transmits the data to host computer 10 (S619 and 5620). Thus, the processing for reading is completed.

Other

The foregoing described an embodiment in which logic volume 17 was assigned to host computer 10 by management terminal 15. It is, however, also allowable to introduce software for assigning the logic volumes to the individual host computers 10, and to operate the user interfaces of the individual host computers 10 to assign logic volumes 17. In this case, for example, the data related to the assignment are exchanged among the host computers 10 or are stored in local storage 11 or in management terminal 15, so that individual host computers 10 are allowed to make a reference thereto through LAN 16 and to recognize the state of assigning logic volumes 17.

Further, in the foregoing embodiment host computer 10 accesses remote storage 14 through local storage 11. However, it is also allowable to connect, for example, to SAN 12, communication means for connection to remote storage 14, so that host computer 10 directly accesses remote storage 14 through the communication means.

Moreover, local storage 11 and remote storage 14 need not necessarily be disk array units but may be storage units of any other kind, such as storage units using a semiconductor disk. A person skilled in the art will understand that other variations and modifications are possible which fall within the spirit and scope of the invention, which is not limited to the exemplary illustrations but is defined by the attached claims.

1. A method of controlling a storage system, comprising:
a first storage unit;
user units connected to the first storage unit maintaining communication therewith, and exchange data to the storage region offered by the storage unit;
an auxiliary storage unit connected to the first storage unit maintaining communication therewith so as to offer a storage region for expanding the storage region offered by said first storage unit; and
a management unit connected to the first storage unit and to the user units maintaining communication therewith, and assigns the storage region to the user units; wherein
the storage unit sends, to the management unit, a capacity calculated from the capacity of the storage region which can be offered by the first storage unit itself and from the capacity of the storage region offered by the auxiliary storage unit; and
the management unit receives the calculated capacity and recognizes it as an upper-limit capacity that can be assigned to the user units from the first storage unit or from the auxiliary storage unit.

2. A method of controlling a storage system, comprising:
a first storage unit;
user units connected to the first storage unit maintaining communication therewith, and exchanges data to the storage region offered by the first storage unit; and
an auxiliary storage unit connected to the first storage unit maintaining communication therewith so as to offer a storage region for expanding the storage region offered by said first storage unit; wherein
the first storage unit sends, to the user units, a capacity calculated from the capacity of the storage region which can be offered by the first storage unit itself and from the capacity of the storage region offered by the auxiliary storage unit; and
the user units recognize the calculated capacity that is received as an upper-limit capacity that can be assigned to the user units in assigning the storage region offered by the first storage unit or by the auxiliary storage unit.

3. A method of controlling a storage system according to claim 1, wherein the first storage unit offers, to the user units, the storage region in a unit of a logic volume which is logically compiled on a physical storage region offered by the first storage unit or by the auxiliary storage unit.

4. A method of controlling a storage system according to claim 2, wherein the first storage unit offers, to the user units, the storage region in a unit of a logic volume which is logically compiled on a physical storage region offered by the first storage unit or by the auxiliary storage unit.

5. A method of controlling a storage system according to claim 3, wherein the first storage unit transmits the added or subtracted capacity set for each of the logic volumes to the management unit or to the user units.

6. A method of controlling a storage system according to claim 5, wherein the first storage unit offers, to the management unit or to the user units, the capacity set for each of the plurality of logic volumes, and sets the calculated capacity for the logic volume compiled by using said auxiliary storage unit relying upon a capacity set for said different logic volume.

7. A method of controlling a storage system according to claim 1, wherein the management unit is equipped with a user interface for specifying the storage capacity assigned to the user units with the above[?] upper-limit capacity as a limit.

8. A method of controlling a storage system according to claim 2, wherein the user units are equipped with a user interface for specifying the storage capacity assigned to the user units themselves with the above[?] upper-limit capacity as a limit.

9. A method of controlling a storage system according to claim 1, wherein the auxiliary storage unit is installed at a place remote from the storage unit.

10. A method of controlling a storage system according to claim 1, wherein means for connecting the user units to the storage unit maintaining communication is a SAN.

11. A storage unit that works as said first storage unit in a method of controlling a storage system of claim 1.

12. A storage unit that works as said auxiliary storage unit in a method of controlling a storage system of claim 1.

13. A management unit that works as said storage unit in a method of controlling a storage system of claim 1.

14. Storage units in a storage system in which a plurality of the storage units are connected together through a fiber channel to write and read the data based upon a request from a data processing unit, and which includes a management unit for assigning the plurality of storage units connected to the fiber channel to the data processing units; wherein
the storage units are connected, through a dedicated circuit, to other storage units that write or read the data in response to the requests from the storage units, and possess data for managing the state of use of the other storage units; and
the storage units refer to the data for managing the state of use, add up or subtract the storage capacity that can be offered from the storage units to the data processing unit and the stored capacity in the other storage units, and sends, to the management unit, the capacity that can be assigned to the data processing units.
